(19) United States
(12) Patent Application Publication
(10) Pub. No.: US 2009/0219915 A1
(43) Pub. Date: Sep. 3, 2009

(54) DISTRIBUTED REQUEST QUEUE FOR A DATA COMMUNICATION SYSTEM, AND RELATED OPERATING METHODS

(75) Inventors: Edward Kerry ORCUTT, Scottsdale, AZ (US); Dean Paul VANDEN HEUVEL, Chandler, AZ (US)

Correspondence Address: INGRASSIA FISHER & LORENZ, P.C. (GD), 7010 E. COCHISE ROAD, SCOTTSDALE, AZ, 85253, US

(73) Assignee: GENERAL DYNAMICS C4 SYSTEMS, INC., Scottsdale, AZ (US)

(21) Appl. No.: 12/039,447

(22) Filed: Feb. 28, 2008

(51) Int. Cl. H04B 7/212

(52) U.S. Cl. 370/347

(57) ABSTRACT

A user equipment (UE) device and associated operating techniques can be utilized to manage the queuing of network service requests in a distributed manner throughout a data communication system. The request queuing methodology leverages request queues maintained at UE devices within the system. An embodiment of a UE device that supports such request queuing includes a processor and a request queue coupled to the processor. The request queue is configured to queue one or more requests for network resources as instructed by the processor, resulting in one or more held requests. The UE device also includes a receiver element coupled to the processor. The receiver element is configured to receive a notification from the network communication component, where, in response to receiving the notification, the processor prepares the one or more held requests for transmission to the network communication component at different times.

### STATEMENT REGARDING FEDERALLY SPONSORED RESEARCH OR DEVELOPMENT

The United States government may have certain rights to some or all of the inventive subject matter of the present application as provided for by the terms of Contract Number N00039-04-C-2009 awarded by Space and Naval Warfare Systems Command (SPAWAR).

### TECHNICAL FIELD

Embodiments of the subject matter described herein relate generally to data communication systems. More particularly, embodiments of the subject matter relate to the queuing of network resource requests by user equipment devices.

### BACKGROUND

The prior art is replete with different types of data communication systems. Wireless data communication systems, such as cellular-based telecommunication systems, are often used for commercial, government, military, and civilian applications. A wireless system typically includes one or more centralized network components that service a plurality of wireless mobile units within its range. For example, a cellular telecommunication system can include a base station (usually, multiple base stations spread across a geographical coverage region), which supports wireless communication with cellular devices within its operating range. In practice, a wireless network component can only support a limited number of wireless mobile units, due to limited available operating resources (bandwidth, access channels, operating power, etc.). Furthermore, modern wireless mobile units have developed into multi-function devices that are capable of establishing multiple data communication links with a wireless network component for purposes of supporting voice communication, data communication, text messaging, web browsing, and the like. These multi-function devices can put further strain on the limited network resources available to the wireless network component.

In an attempt to manage the influx of requests for network resources, some data communication systems have implemented request queues in a centralized manner. In other words, a network component, such as a cellular base station or a component that cooperates with a cellular base station, receives all requests from the mobile units and determines whether to grant a given request or to deny and queue a given request. Unfortunately, when the network is congested the mere act of sending requests from the mobile units to the network component consumes the communication resources, thus further reducing the availability of system resources needed to establish wireless data communication links with the mobile units. Moreover, implementation of such a centralized request queuing system may require additional hardware, software, and/or significant modifications to the central equipment, which can be expensive and difficult to realize.

### BRIEF SUMMARY

The subject matter described herein is suitable for implementation in a data communication system such as a wireless telecommunication system. The system incorporates request queues into user equipment (UE) devices supported by a network communication component. The UE devices queue requests for network resources and transmit held requests under the control of the network communication component. This distributed queuing technique can be implemented in a manner that conserves the network resources. Effectively, the network communication component maintains and controls an aggregate queue that is formed by a plurality of UEs operating in the manner described herein, which allows FIFO operation among multiple UEs.

The above and other aspects may be carried out by an embodiment of a method for managing requests for resources in a data communication system having a network communication component. The method involves maintaining a request queue at a UE device, queuing one or more requests for network resources in the request queue, receiving a notification from the network communication component, and transmitting queued requests beginning at a designated time, in response to receiving the notification.

The above and other aspects may be found in an embodiment of a UE device that manages requests for network resources in a data communication system having a network communication component. The UE device includes a processor, a request queue coupled to the processor, and a receiver element coupled to the processor. The request queue is configured to queue one or more requests for network resources as instructed by the processor, resulting in one or more held requests, and the receiver element is configured to receive a notification from the network communication component. After receiving the notification, the processor may prepare the one or more held requests for transmission to the network communication component beginning at a designated time that is influenced by queuing times of the one or more held requests.

The above and other aspects may be carried out by an embodiment of a method for managing requests for resources in a wireless data communication system having a wireless network communication component that provides wireless service to wireless UE devices. This method involves transmitting a restricted service notification from the wireless network communication component, receiving the restricted service notification at a plurality of supported UE devices, each of the supported UE devices comprising a respective request queue, and, in response to receiving the restricted service notification, each of the plurality of supported UE devices queuing any new requests for network resources in its respective request queue. The method also involves transmitting a service supported notification from the wireless network communication component, receiving the service supported notification at one or more of the supported UE devices, and, in response to receiving the service supported notification, each of the one or more of the supported UE devices transmitting any queued requests, beginning at a calculated time that promotes a collective first in, first out behavior.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a wireless data communication system that supports request queuing;

FIG. 2 is a schematic representation of an embodiment of a wireless user equipment device that supports request queuing;

FIG. 3 is a diagram that depicts the timing of various messages in an embodiment of a wireless data communication system that supports request queuing;

FIG. 4 is a diagram that depicts the timing of various messages in another embodiment of a wireless data communication system that supports request queuing;

FIG. 5 is a flow chart that illustrates an embodiment of a network component process that supports request queuing for a wireless data communication system; and

FIG. 6 is a flow chart that illustrates an embodiment of a user equipment process that supports request queuing for a wireless data communication system.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 2 depicts one exemplary arrangement of elements, additional intervening elements, devices, features, or components may be present in an embodiment of the depicted subject matter.

For the sake of brevity, conventional techniques related to wireless data communication, signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

A data communication system as described herein employs a request queue architecture that is distributed among the UE devices supported by a centralized network communication component. Although the techniques and technologies described herein may also be utilized in a non-wireless system, the illustrated embodiments are all directed to a wireless implementation. In certain embodiments, the request queues are controlled and managed such that requests held by UE devices are sent to the network communication component in a collective first in, first out (FIFO) manner. In this way, the individual request queues are preferably controlled and managed such that the end effect is an aggregate FIFO operation over many UEs. In other embodiments, held requests can be sent in a pseudorandom order that does not depend on the amount of time the requests have been queued. In certain embodiments, the system integrates a priority scheme with the distributed queuing methodology such that the network communication component can restrict or allow requests for UE devices depending upon the designated priority of the UE devices. Thus, by broadcasting the priority level at which requests are being denied, the UE devices at or below that priority level can queue requests that would otherwise be denied by the network communication component. Thereafter, when network congestion clears to the point where the queued requests are eligible to be served, UE devices having the appropriate priority can transmit their held requests.

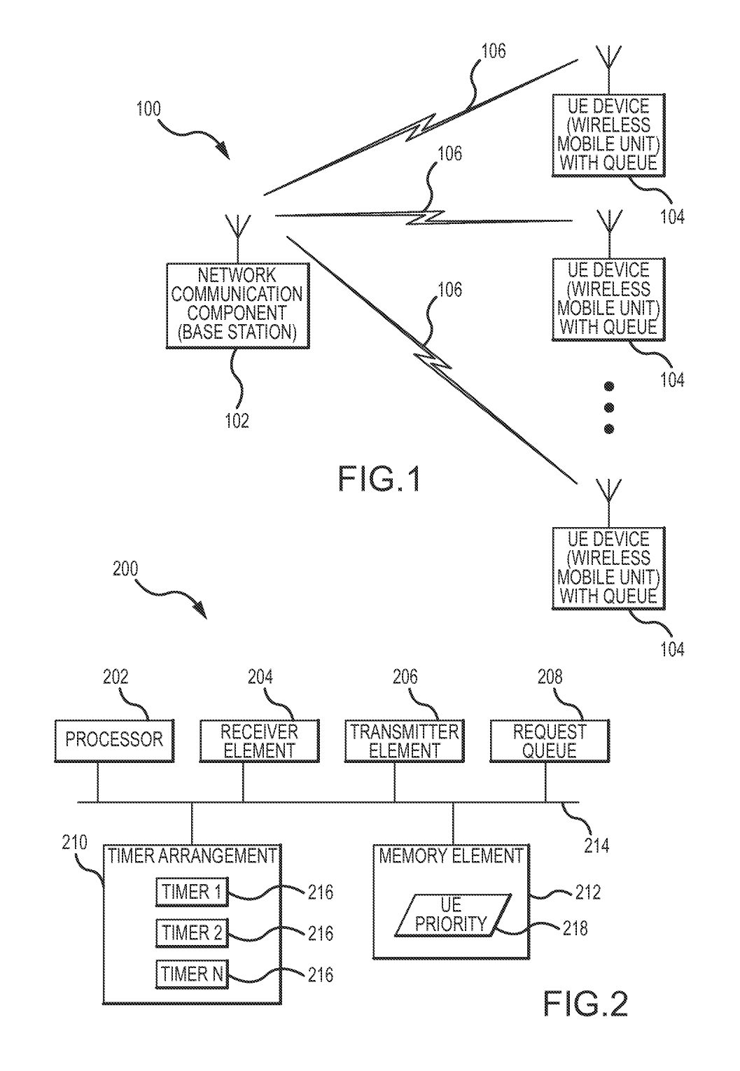

FIG. 1 is a schematic representation of an embodiment of a wireless data communication system 100 that supports request queuing. System 100 generally includes, without limitation, a network communication component 102 and a plurality of UE devices 104 supported by network communication component 102. Although not a requirement, this particular embodiment of system 100 is realized as a cellular telecommunication system, where network communication component 102 is a base station and UE devices 104 are wireless mobile units that communicate with network communication component 102 using wireless links 106. In operation, system 100 may support multiple concurrent wireless links 106 between network communication component 102 and any given UE device 104. The configuration, operation, and functionality of wireless communication systems, cellular telecommunication systems, and data communication systems are generally well known and, therefore, such known aspects will not be described in detail here.

Network communication component 102 may represent a central transmit and receive station that supports a plurality of UE devices 104. The ellipses in FIG. 1 indicate that network communication component 102 can support any number of UE devices 104, including more or less than three (as shown). The illustrated embodiment assumes that each UE device 104 includes a respective request queue that is maintained and managed by the UE device 104. In an actual deployment, however, system 100 may be suitably configured to support other UE devices (not shown) that do not include request queues and, therefore, are not fully compatible with the request queuing methodology described in more detail below.

Each UE device 104 may be a computing device, a telephone, or any device having a particular configuration and platform. For example, a given UE device 104 may be realized as: a mobile telephone; a portable computer, such as a personal digital assistant, a pocket personal computer, a tablet computer, or a laptop computer; a video game device, such as a portable video game device or a video game console; a medical device having wireless capabilities; a digital media player having wireless capabilities; or the like. The particular physical configuration of a UE device 104, the applications hosted by a UE device 104, and the manner in which a UE device 104 communicates with network communication component 102 can be selected to suit the needs of the individual user and/or to accommodate the particular system deployment.

The request queuing technique implemented by system 100 need not rely on any appreciable hardware or software modifications to network communication component 102. Instead, system 100 can implement distributed request queuing by leveraging overhead signaling channels that might already be supported by an existing wireless network architecture, and by leveraging native processing by UE devices 104. In this regard, FIG. 2 is a schematic representation of an embodiment of a wireless UE device 200 that supports request queuing. In a practical system deployment, a plurality of UE devices 200 are operated in a manner that achieves an aggregate and distributed request queue as described herein. UE device 200 is suitably configured to manage requests for network resources on behalf of a network communication component. This embodiment of UE device 200 generally includes, without limitation: a processor 202; a receiver element 204; a transmitter element 206; a request queue 208; a timer arrangement 210; and a memory element 212. Some or all of these elements may be coupled together with a bus 214 or any suitable interconnection arrangement or architecture. Depending upon the particular implementation, UE device 200 may include, without limitation: user interface features; a display element; a wired data communication interface; and other components that may be utilized to support conventional features of UE device 200. Such conventional features will not be described in detail herein.

Processor 202 is suitably configured to support the operation of UE device 200, including the request queuing scheme described in more detail herein. Processor 202 may be realized with any number of hardware, software, and/or firmware components, and processor 202 may include any number of logical or functional modules. Processor 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. In practice, processor 202 may be realized as a microprocessor, a controller, a microcontroller, or a state machine. Moreover, processor 202 may be implemented as a combination of computing devices, e.g., a combination of a digital signal processor and a microprocessor, a plurality of microprocessors, one or more microprocessors in conjunction with a digital signal processor core, or any other such configuration. In addition, although FIG. 2 depicts certain elements as distinct blocks or modules, processor 202 may include or incorporate functional components (or portions thereof) of UE device 200, such as, request queue 208 or timer arrangement 210.

In practice, processor 202 may be suitably configured to perform and/or support the various operations, features, techniques, functions, and operations described herein. For example, processor 202 may process received messages and notifications related to the request queuing technique, control or instruct the queuing of requests in request queue 208, prepare held requests for transmission by transmitter element 206, compare a designated priority of UE device 200 to a priority level received from the network communication component, and the like.

Receiver element 204 is suitably configured to receive wireless signals in a manner that is compliant with the particular wireless transmission schemes and protocols employed by the system. Likewise, transmitter element 206 is suitably configured to transmit wireless signals in a manner that is compliant with the particular wireless transmission schemes and protocols employed by the system. In certain embodiments, receiver element 204 and transmitter element 206 may be integrated into a single operating component, such as a radio module or a communication module, where such a module may include or utilize processing logic that is suitably configured to support the data communication protocols, schemes, and techniques utilized by UE device 200. In practice, a communication module or a portion thereof may be considered to be part of processor 202. A communication module may be configured to: process data received or transmitted by receiver element 204 or transmitter element 206; process data received or transmitted by a short range wireless radio; process data received or transmitted by a wired interface; and/or process data received or transmitted by other technologies and techniques supported by UE device 200.

For wireless communication of data, receiver element 204 and transmitter element 206 may support any number of suitable wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB.

Alternatively (or additionally), UE device 200 may be configured to support communication of data over a cable, a wired connection, or other physical link. Accordingly, UE device 200 may support any number of suitable data communication protocols, techniques, or methodologies, including, without limitation: Ethernet; home network communication protocols; USB; IEEE 1394 (Firewire); hospital network communication protocols; and proprietary data communication protocols. Moreover, receiver element 204 and transmitter element 206 may be suitably configured to support data communication using any of these techniques.

In addition to standard and conventional receive functions, receiver element 204 may be capable of receiving notifications that might be broadcast by the network communication component using, for example, one or more overhead channels, an IP-based multicast methodology, or the like. For the embodiment described here, receiver element 204 can receive restricted service notifications and service supported notifications (where these notifications may or may not identify specific priority levels that are currently supported and/or not supported by the network communication component). As described in more detail below, a restricted service notification is issued when the network communication component would like certain UE devices to temporarily queue their requests for network resources. Conversely, a service supported notification is issued when the network communication component would like certain UE devices to clear their request queues.

In addition to standard and conventional transmit functions, transmitter element 206 may be capable of transmitting held/queued requests (when cleared to do so) from UE device 200. To avoid flooding the network communication component with held requests, UE device 200, along with other UE devices supported by the network communication component, preferably transmits held requests beginning at a designated or calculated time that is determined by processor 202. As explained in more detail below, the timing of the transmission of the first held request can be influenced by the queuing times of the held requests (e.g., a request held by one UE for a relatively long time is transmitted quickly, while a request held by another UE for a relatively short time is transmitted after a longer period of time). Moreover, transmitter element 206 may be suitably configured and controlled to transmit held requests at different times, in a strict FIFO manner, in a FIFO-like manner, in a strict LIFO manner, in a LIFO-like manner, in a random or pseudorandom manner, and/or in accordance with an access channel timing scheme of the data communication system.

Request queue 208 may be realized as an appropriate amount of memory, and request queue 208 is configured to queue one or more requests for network resources as instructed by processor 202. As mentioned above, request queuing may be initiated when UE device 200 receives an applicable restricted service notification from the network communication component. In the context of a cellular telecommunication system embodiment, each request represents a channel access request for a base station, and UE device 200 may queue any number of requests as needed. For example, under a restricted service condition, UE device 200 may queue separate channel access requests corresponding to a new voice call, an email transmission, a text message transmission, the launching of a web browser, etc.

The transmit order of held requests may be influenced, controlled by, or determined in response to the operation of timer arrangement 210. Moreover, timer arrangement 210 can be utilized to transmit queued requests at a calculated time that promotes a collective first in, first out behavior among a plurality of UE devices 200, relative to the network communication component. As depicted in FIG. 2, timer arrangement 210 is configured to maintain respective timers for the queued requests. Accordingly, timer arrangement 210 may include any number of individual timers 216, where one timer 216 is maintained for each held request. In certain embodiments, timer arrangement 210 starts a timer 216 for a request in response to queuing of that request in request queue 208. Of course, the reference point for the actual start time of a timer 216 can be arbitrary, as long as all timers 216 follow the same scheme. After receiving an applicable service supported notification, UE device 200 can use the time accumulated by each timer 216 to determine how best to purge request queue 208. For example, the request having the longest queuing time can be transmitted first, while the request having the shortest queuing time can be transmitted last.

Memory element 212 may be realized as RAM memory, flash memory, EPROM memory, EEPROM memory, registers, a hard disk, a removable disk, a CD-ROM, or any other form of storage medium known in the art. In this regard, memory element 212 can be coupled to processor 202 such that processor 202 can read information from, and write information to, memory element 212. In the alternative, memory element 212 may be integral to processor 202. As an example, processor 202 and memory element 212 may reside in an ASIC. In this example, memory element 212 is utilized to store at least one designated priority 218 for UE device 200. Although shown separately in FIG. 2, memory element 212 may also be used to implement request queue 208. Moreover, memory element 212 can be used to store data associated with the various applications supported by UE device 200, and to store other information that may relate to conventional operating features of UE device 200.

The system can use a priority scheme to control request queuing based on different classes or categories of UE devices, users, subscription levels, or the like. For example, UE devices having the highest relative priority might be the last group of devices instructed to queue their requests and the first group of devices allowed to purge their request queues. On the other hand, UE devices having the lowest relative priority might be the first group of devices instructed to queue their requests and the last group of devices allowed to purge their request queues. The number of priority levels can vary, depending upon the intended use and deployment of the data communication system. For example, one system embodiment may utilize up to ten different priority levels.

For simplicity, the embodiment described here assumes that each UE device 200 has only one designated priority within the domain of the data communication system, relative to other UE devices operating within that domain. In practice, however, a single UE device 200 may be configured with multiple designated priorities 218, which may correspond to different users/subscribers of that UE device 200, different operating modes of that UE device 200, different geographical regions, different operating times, or the like. It should be apparent that the prioritized schemes described here can also be applied in the context of UE devices that have more than one designated priority.

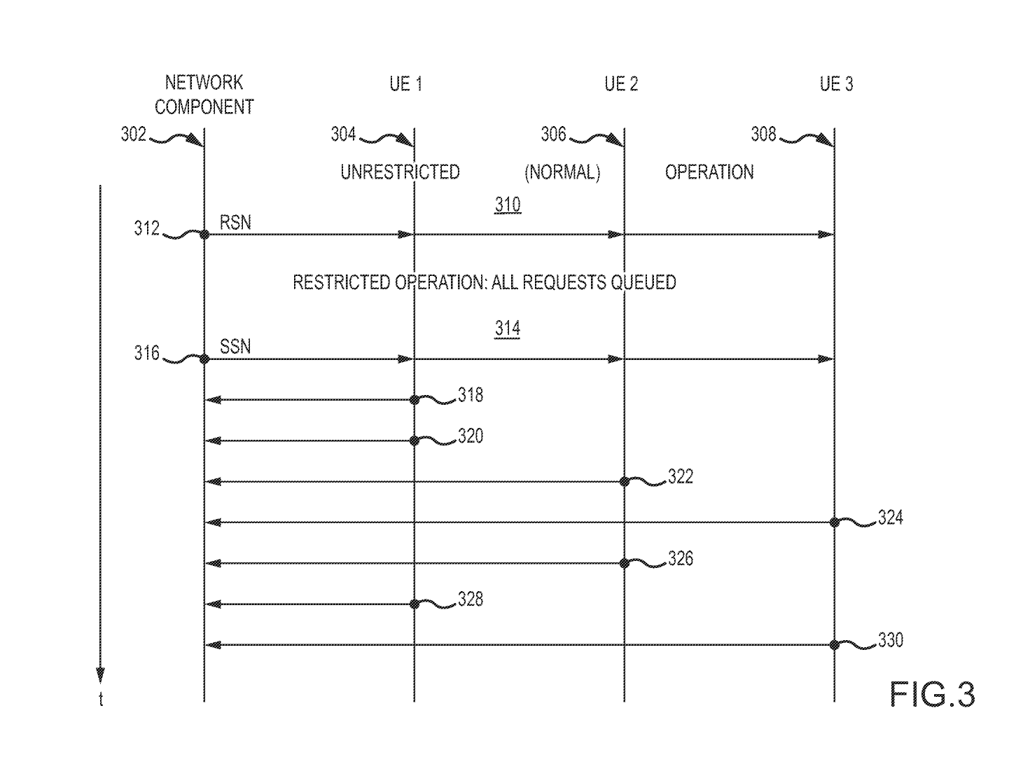

A network communication component and UE devices configured as described herein can cooperate to implement a distributed request queue architecture that conserves network resources by holding requests at the UE devices. FIG. 3 is a diagram that depicts the timing of various messages in one embodiment of a wireless data communication system that supports request queuing. This simple example assumes that a network communication component 302 communicates with three UE devices 304, 306, and 308, and that the system does not implement the priority scheme described above. In FIG. 3, the vertical scale represents time increasing in the downward direction and the vertical lines represent network communication component 302 and UE devices 304, 306, and 308.

A time period 310 represents a period of unrestricted and normal operation of the system, where requests from the UE devices are being accepted by network communication component 302. In other words, none of the UE devices are queuing requests during time period 310. Then, network communication component 302 broadcasts a restricted service notification (RSN) 312, which is received and processed by each of the UE devices. For this example, RSN 312 results in a restricted operation period 314, during which all requests are queued by the UE devices. In other words, RSN 312 instructs each of the UE devices to begin queuing its respective requests.

Thereafter, network communication component 302 broadcasts a service supported notification (SSN) 316, which is received and processed by each of the UE devices. Notably, since no prioritization scheme is employed here, SSN 316 may include, convey, or represent a “purge queue” command that authorizes all of the UE devices to begin clearing their request queues. In practice, network communication component 302 and all of the UE devices can be synchronized in time (using an overhead signaling channel, a reference clock signal, or the like), such that held requests are transmitted in accordance with a particular timing scheme. In certain embodiments, the held requests may be sent in accordance with the access channel timing scheme utilized by the particular data communication system. For example, held requests can be transmitted at specified 20 millisecond intervals (this 20 millisecond interval is commonly used for access channel timing in cellular communication systems).

FIG. 3 depicts one of many possible scenarios that accommodate the transmission of queued requests to network communication component 302. For this example, UE device 304 transmits its first held request 318 followed by its second held request 320. Next, UE device 306 transmits its first held request 322. Thereafter, UE device 308 transmits its first held request 324. Thereafter, UE device 306 transmits its second held request, then UE device 304 transmits its third held request 328, and then UE device 308 transmits its second held request 330. As explained in more detail below, the particular transmission time of the first held request of each UE device can be influenced by, determined by, or calculated from the queuing time of the held requests. This behavior promotes transmission of held requests in a time-staggered manner, from the perspective of the network communication component. It should be appreciated that each UE device may be suitably configured to transmit its own held requests in sequential order and in accordance with the predetermined timing scheme. Consequently, although not shown in FIG. 3, more than one UE device may transmit a held request during the same time slot. Furthermore, certain system embodiments may be able to process new requests transmitted by UE devices 304, 306, or 308 after SSN 316 has instructed the UE devices to purge their request queues.

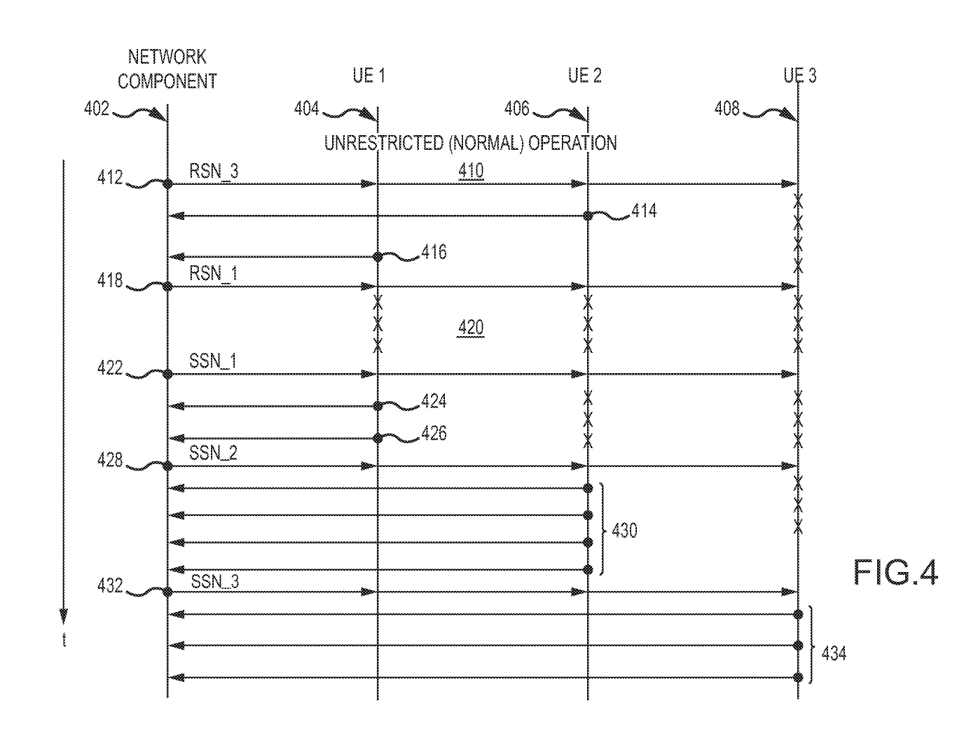

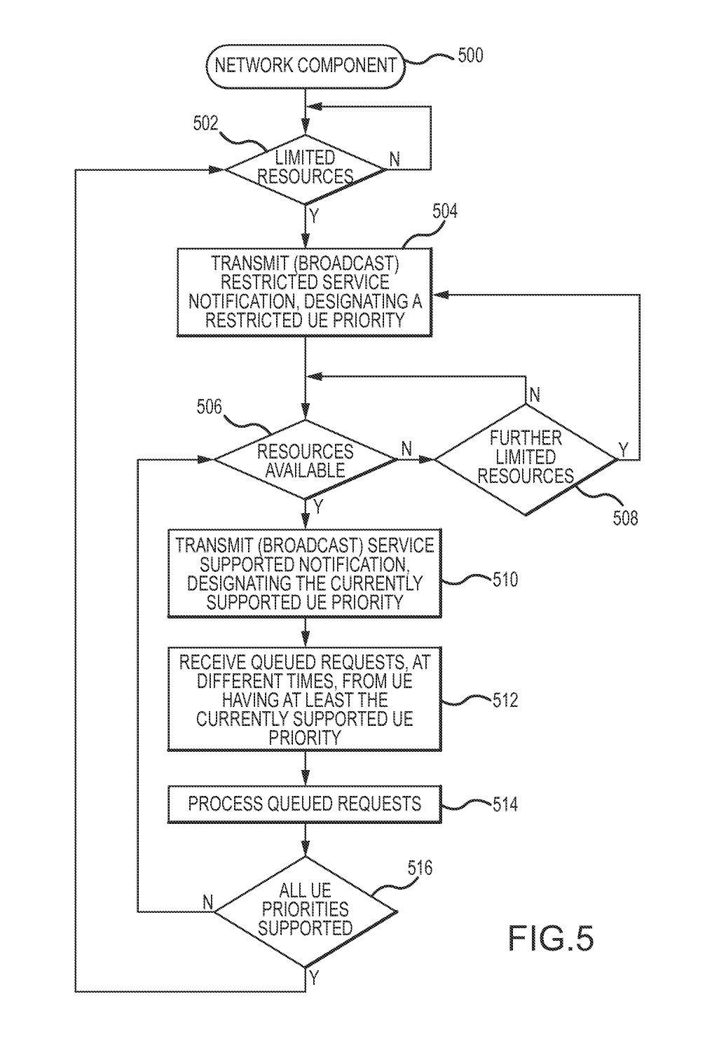

FIG. 4 is a diagram that depicts the timing of various messages in another embodiment of a wireless data communication system that supports request queuing. This simple example assumes that a network communication component 402 communicates with three UE devices having different designated priorities: a UE device 404 having the highest relative priority; a UE device 406 having an intermediate relative priority; and a UE device 408 having the lowest relative priority. An embodiment of the system may or may not assign priorities to UE devices. For example, a UE device may be provisioned with a maximum priority or priority range with each individual service request taking on a priority value from the assigned range, where the user is able to select the priority. In other words, the request may have a priority, which may be a result of the UE device having a designated static priority such that all of its requests have the same priority, or a request may be assigned a priority as a result of user input.

As used here, the highest priority (Priority 1 in this example) indicates a UE device that is given preferred access and availability to network resources, while the lowest priority (Priority 3 in this example) indicates a UE device that is provided with the least amount of access and availability to network resources during times of network congestion. In FIG. 4, the vertical scale represents time increasing in the downward direction and the vertical lines represent network communication component 402 and UE devices 404, 406, and 408.

A time period 410 represents a period of unrestricted and normal operation of the system, where requests from the UE devices are being accepted by network communication component 402. Then, network communication component 402 broadcasts a restricted service notification 412 (labeled RSN_3), which is received and processed by each of the UE devices. For this example, RSN 412 includes, indicates, conveys, or identifies Priority 3 as a priority level restricted by network communication component 402. Consequently, although RSN 412 may be received and processed by each of the UE devices, RSN 412 is only acted upon by UE device 408 (which is a Priority 3 device). Although not depicted in FIG. 4, RSN 412 would also be acted upon by any other UE device having a designated priority of Priority 3 or less (e.g., Priority 4, Priority 5, etc.).

In response to RSN 412, UE device 404, UE device 406, and any other UE device having a designated priority higher than Priority 3 will continue operating as usual, without performing request queuing. In contrast, UE device 408 responds to RSN 412 by queuing its requests. The crosshatching in FIG. 4 represents periods of request queuing by the UE devices. During the period immediately following the transmission of RSN 412, UE device 406 may transmit one or more requests 414 to network communication component 402, and/or UE device 404 may transmit one or more requests 416 to network communication component 402. As explained previously, during this period UE devices 404 and 406 may request network resources in accordance with a specified access channel timing scheme.

FIG. 4 depicts a scenario where network congestion initially increases and then decreases over time. Thus, network communication component 402 eventually broadcasts another restricted service notification 418 (labeled RSN_1), which is received and processed by each of the UE devices. For this example, RSN 418 includes, indicates, conveys, or identifies Priority 1 as a priority level restricted by network communication component 402. Thus, RSN 418 is applicable to all of the UE devices 404, 406, and 408. In response to RSN 418, UE device 404 and UE device 406 will begin queuing their requests, and UE device 408 will continue queuing its requests. This results in a period 420 of fully restricted operation, during which all requests are being held. This particular example transitions from Priority 3 restriction to Priority 1 restriction without implementing an intervening Priority 2 restriction. Of course, such a Priority 2 restriction can be utilized to gradually transition to Priority 1 restriction.

Thereafter, network communication component 402 broadcasts a service supported notification 422 (labeled SSN_1), which is received and processed by each of the UE devices. For this example, SSN 422 includes, indicates, conveys, or identifies Priority 1 as a priority level supported by network communication component 402. Consequently, although SSN 422 may be received and processed by each of the UE devices, SSN 422 alters the operation of UE device 404 only (since UE device 404 is a Priority 1 device). Accordingly, UE device 404 (along with other Priority 1 devices) is now authorized to begin clearing its request queue. FIG. 4 depicts UE device 404 transmitting a first held request 424 and a second held request 426 to network communication component 402. Again, the held requests may be sent in accordance with the access channel timing scheme utilized by the particular data communication system. Moreover, each of the Priority 1 devices controls the transmit time of its first held request in a manner that promotes FIFO behavior.

The example shown in FIG. 4 assumes that network congestion continues to lessen as time passes. In this regard, network communication component 402 broadcasts another service supported notification 428 (labeled SSN_2), which is received and processed by each of the UE devices. For this example, SSN 428 includes, indicates, conveys, or identifies Priority 2 as a priority level supported by network communication component 402. Consequently, although SSN 428 may be received and processed by each of the UE devices, SSN 428 alters the operation of UE device 406 only (since UE device 406 is a Priority 2 device). Accordingly, UE device 406 is now authorized to begin clearing its request queue. FIG. 4 depicts UE device 406 sequentially transmitting four held requests 430 to network communication component 402.

As described above for the Priority 1 devices, each of the Priority 2 devices may be suitably configured to control the transmit time of its first held request in a manner that promotes FIFO behavior. Furthermore, in certain embodiments, transmission of held requests 430 may be delayed for a designated wait time to ensure that a certain amount (preferably, all) of the requests queued by Priority 1 UE devices have already been sent. As depicted in FIG. 4, during the transmission of queued requests by UE device 406, UE device 408 (a Priority 3 device) continues to queue its requests. Moreover, while UE device 406 transmits its queued requests, it may be possible for UE device 404 (and other Priority 1 UE devices) to transmit new requests to network communication component 402.

Eventually, network communication component 402 broadcasts yet another service supported notification 432 (labeled SSN_3), which is received and processed by each of the UE devices. For this example, SSN 432 includes, indicates, conveys, or identifies Priority 3 as a priority level supported by network communication component 402. Consequently, although SSN 432 may be received and processed by each of the UE devices, SSN 432 alters the operation of UE device 408 only (since UE device 408 is a Priority 3 device). Accordingly, UE device 408 is now authorized to begin clearing its request queue. FIG. 4 depicts UE device 408 sequentially transmitting four held requests 434 to network communication component 402. As described above for the Priority 1 devices, each of the Priority 3 devices may be suitably configured to control the transmit time of its first held request in a manner that promotes FIFO behavior.

In certain embodiments, the network communication component controls the timing of its SSNs such that all UEs (at the given priority) have the opportunity to clear the request queues before the network communication component allows UEs at a lower or worse priority to begin clearing their request queues. This wait or delay time (as regulated by the network communication component) can be employed to minimize collisions of the transmission of held requests and to instill FIFO ordering in some embodiments. Alternatively, the UEs may be configured to delay transmission of held requests 434 to ensure that a certain amount (preferably, all) of the requests queued by Priority 2 UE devices have already been sent. In addition, while UE device 408 transmits its queued requests, it may be possible for UE device 404 and UE device 406 (and other Priority 1 and Priority 2 UE devices) to transmit new requests to network communication component 402.

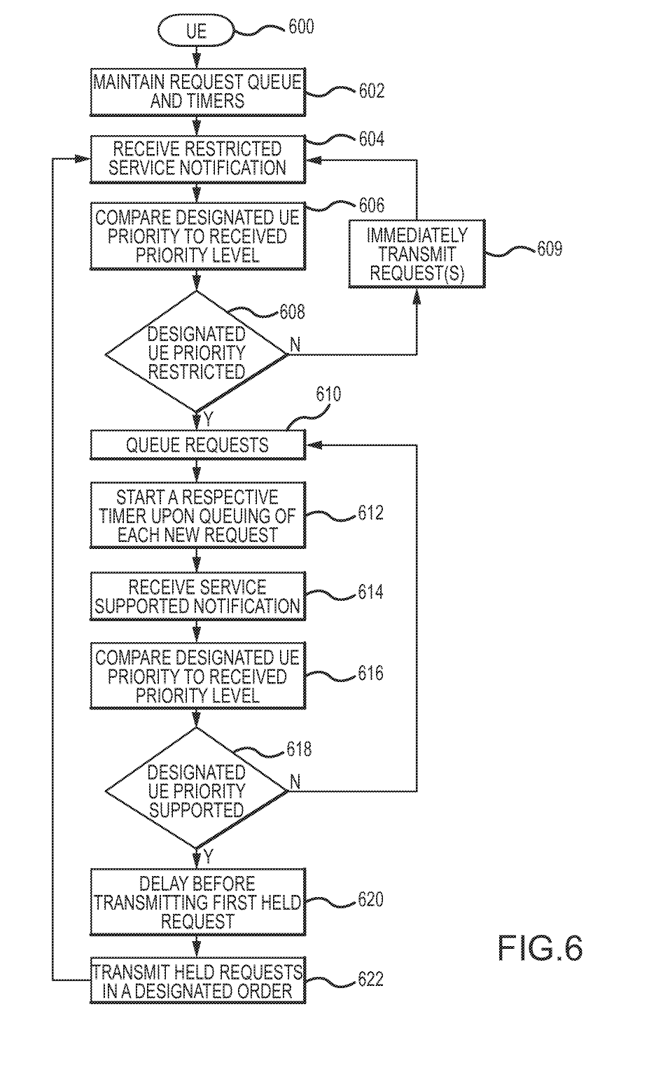

The examples described above with reference to FIG. 3 and FIG. 4 are not intended to be limiting or exhaustive of all possible request queuing scenarios. Rather, the system can be suitably configured to handle many different operating conditions, system architectures, and number of UE devices. In this regard, FIG. 5 is a flow chart that illustrates an embodiment of a generalized network component process 500 that supports request queuing for a wireless data communication system, and FIG. 6 is a flow chart that illustrates an embodiment of a generalized UE process 600 that supports request queuing for a wireless data communication system. The various tasks performed in connection with process 500 and process 600 may be performed by software, hardware, firmware, or any combination thereof. For illustrative purposes, the following description of process 500 and process 600 may refer to elements mentioned above in connection with FIG. 1 and FIG. 2. In practice, portions of a described process may be performed by different elements of the described system, e.g., a network communication component, a UE device, or a functional element thereof. It should be appreciated that a described process may include any number of additional or alternative tasks, the tasks shown in FIG. 5 and FIG. 6 need not be performed in the illustrated order, and a described process may be incorporated into a more comprehensive procedure or process having additional functionality not described in detail herein.

Referring to FIG. 6, an instantiation of UE process 600 can be independently performed by each UE device operating within the domain of the system. Process 600 maintains a request queue at the UE device (task 602), where the request queue is configured as described above with reference to FIG. 2. Collectively, the request queues of multiple UE devices represents an aggregate queue for the network communication component. Referring to FIG. 5, network component process 500 can be performed by a network communication component, such as a base station, that supports UE devices. If process 500 determines (query task 502) that available network resources have become limited, or will become limited in the near future, then the network communication component will transmit or broadcast (task 504) an appropriate restricted service notification that is intended for UE devices within its operating range. The restricted service notification identifies or conveys a priority level restricted by the network communication component. If query task 502 determines that resources are not limited, then query task 502 can be repeated until it detects a limited resource condition. Thus, transmission of the restricted service notification (and/or the characteristics or content of the restricted service notification) may be dictated by a present operating status of the network communication component. For the wireless embodiment described here, the present operating status may be a wireless resource status, e.g., a metric related to available operating bandwidth, available processing resources in the base station, the number of available access channels, the number of currently active wireless links, network traffic or data flow volume, or the like.

Process 600 assumes that the UE device receives the restricted service notification (task 604). In practice, the restricted service notification may be received by a plurality of UE devices, each configured to perform process 600. The UE device compares its designated priority to the received priority level (task 606) to determine whether or not to queue future requests. If the designated priority of the UE device has been restricted (query task 608), then process 600 initiates the queuing (task 610) of one or more requests for network resources in the request queue of the UE device. Thus, task 610 is performed to obtain one or more held/queued requests for the UE device. If query task 608 determines that the designated priority is not restricted, then process 600 can immediately transmit (task 609) any requests. In other words, task 609 results in the transmission (without queuing) of requests having sufficient priority. After task 609, process 600 may exit or be re-entered at task 604 to await another restricted service notification. Consequently, a given UE device will queue new requests only if the priority level conveyed in a restricted service notification indicates that the designated priority of that UE device is currently restricted by the network communication component.

As described above with reference to FIG. 2, the UE device preferably maintains timers for its held requests. The UE device may start a respective timer upon queuing a request in the request queue (task 612). In operation, the UE device may maintain any number of separate timers, corresponding to a like number of held requests. For this embodiment, each timer keeps track of the amount of time its associated request has been held in the request queue. Notably, task 612 remains active and new requests continue to be queued until the UE device receives an applicable service supported notification (task 614) from the network communication component.

Referring again to FIG. 5, process 500 monitors the network resources and broadcasts updated restricted service notifications and service supported notifications as needed. For example, following task 504, if additional resources have not become available (query task 506), then process 500 may check whether the network resources have become further limited or restricted (query task 508). If not, then process 500 may be re-entered at query task 506 to continue monitoring the current status of the network resources. If, however, query task 508 determines that the network resources have become further limited, then process 500 may be re-entered at task 504 to broadcast another restricted service notification that designates another restricted priority level. In other words, this iteration of task 504 can be performed to cause another category of UE devices to start queuing requests. The loop associated with task 504, query task 506, and query task 508 can be repeated as needed to initiate request queuing by more and more UE devices in a progressive manner, based on the current system demands and the current operating conditions.

If query task 506 determines that sufficient additional resources have become available, then process 500 can transmit or broadcast (task 510) an appropriate service supported notification that is intended for UE devices within its operating range. The service supported notification identifies or conveys a priority level that is currently supported by the network communication component. In certain embodiments, process 500 can delay the transmission of the service supported notification for a calculated or predetermined period of time to ensure that any queued requests that are pending transmission are sent before the network communication component authorizes the transmission of more held requests. With reference to FIG. 6, process 600 assumes that the service supported notification is received (task 614) by the UE device. In practice, the service supported notification may be received by a plurality of UE devices, each configured to perform process 600. The UE device compares its designated priority to the received priority level (task 616) to determine whether or not it has been authorized to begin transmitting held requests or to immediately transmit new requests. If the designated priority of the UE device is now supported (query task 618), then the UE device can begin processing the held requests for transmission to the network communication component. If query task 618 determines that the designated priority is not currently supported, then process 600 may exit or be re-entered at task 610 to continue queuing requests. Consequently, a given UE device will transmit its held requests only if the priority level conveyed in a service supported notification indicates that the designated priority of that UE device is currently supported by the network communication component.

The illustrated embodiment of process 600 delays transmission of the first held request (task 620) for a wait time, relative to a receipt time of the service supported notification. The timer arrangement of the UE device can be utilized to keep track of this delay. The wait time is used to avoid all UEs sending queued requests simultaneously and, in one embodiment, the wait time can be selected to provide FIFO transmission of queued requests within a given priority by setting the wait time to be inversely proportional to the time spent in queue. In parallel, the network communication component invokes a dwell time to ensure that sufficient time has elapsed to receive all held requests being transmitted by the previously authorized group of UE devices, where the minimum dwell time is the time needed to clear the request queues at a given priority. For example, before sending a service supported notification indicating that Priority 3 UE devices can now purge their request queues, the network communication component ensures that there has been a time interval of at least the dwell time since it sent the notification indicating that Priority 2 UE devices could clear their request queues. In this manner, the network communication component effectively creates an aggregate FIFO effect without requiring a central request queue that services all of the UEs. The individual UEs, using their delay-then-send behavior, cooperate (in a sense) to create the distributed overall queue that exhibits a collective FIFO behavior.

Eventually, process 600 allows the UE device to transmit its held requests in a designated order (task 622) and beginning at a particular time. As explained previously, the held requests are transmitted at different times that might follow an access channel timing scheme of the data communication system. In addition, the timing arrangement of the UE device can be utilized to ensure that held requests are collectively sent to the network communication component in a FIFO (or a FIFO-like) manner. After all of the held requests have been transmitted, the UE device will be operating as usual and process 600 may exit or be re-entered at task 604 to await another restricted service notification.

Referring now to FIG. 5, the network communication component receives the queued requests (or, more accurately, the formerly queued requests) from UE devices having at least the currently supported priority level (task 512). These formerly queued requests are then processed and serviced by the network communication component as usual (task 514). Process 500 may check whether all of the different priority levels are currently supported (query task 516). If so, then the network communication component is operating in an unrestricted and normal mode and process 500 may exit or be re-entered at query task 502 to again monitor for a limited resource condition. If not, then process 500 can be re-entered at query task 506 to check whether the current network resources have sufficiently varied to the point where a service supported notification can be broadcast (indicating an improvement in network resources) or to the point where a restricted service notification can be broadcast (indicating more network congestion).

Although the designated transmission order may be determined in any suitable manner, the following example may be implemented in a practical embodiment. For this example, ELAPSED_QUEUE_TIME represents the time accumulated by a request queue timer for its held request. As mentioned above, this timer starts when the UE device queues the request. When congestion clears such that the queued request is of sufficient priority to be transmitted, the UE device starts a second timer that counts down in increments of a predetermined time increment that is known and synchronized by all UE devices within the particular domain of the network communication component. QUEUE_WAIT_TIME represents this second timer, and the time increment is referred to herein as the transport time interval (TTI). This example also employs a maximum queuing time, indicated by QUEUE_CEILING_TIME.

The number of TTI periods that QUEUE_WAIT_TIME counts is based on QUEUE_CEILING_TIME (in seconds) minus ELAPSED_QUEUE_TIME (in seconds). As an example, if QUEUE_CEILING_TIME is configured to be 60 seconds, the accumulated value of QUEUE_WAIT_TIME is 30 seconds, and the TTI is equal to 20 milliseconds, then (after being cleared to transmit held requests) the UE device will transmit that request after waiting (60−30)×20=600 milliseconds. Conversely, a UE device with a request that had been queued for 50 seconds would wait only (60−50)×20=200 milliseconds. In this way, queued requests are resubmitted in order based on their length of time in the request queue, thereby achieving FIFO behavior in a distributed queue, provided the time in queue is no more than QUEUE_CEILING_TIME. Additionally, queued requests are divided across TTI intervals to decrease the likelihood of collisions of queued requests on any shared channel used to submit requests. Furthermore, the dwell time at each priority level is preferably set to be at least equal to QUEUE_CEILING_TIME×TTI interval.

If the ELAPSED_QUEUE_TIME exceeds the QUEUE_CEILING_TIME, then the ELAPSED_QUEUE_TIME rolls over (resets) and begins anew. This behavior is desirable to minimize the number of queued service requests that are transmitted for any TTI interval. Alternatively, rather than resetting the ELAPSED_QUEUE_TIME, the calculation of the transmit wait time can be adjusted using an appropriate modulo operation.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for managing requests for resources in a data communication system having a network communication component, the method comprising:
maintaining a request queue at a user equipment (UE) device;
queuing one or more requests for network resources in the request queue, to obtain one or more held requests;
thereafter receiving a notification from the network communication component; and
transmitting the one or more held requests beginning at a designated time, in response to receiving the notification.

2. The method of claim 1, wherein:
the data communication system comprises a wireless telecommunication system;
the UE device comprises a wireless mobile unit;
the network communication component comprises a central transmit and receive station that supports a plurality of UE devices, including the UE device; and
each of the requests comprises a channel access request.

3. The method of claim 1, further comprising:
maintaining timers for the one or more held requests; and
for each of the one or more held requests, starting its respective timer upon queuing in the request queue; wherein
the designated time is influenced by the timers.

4. The method of claim 1, wherein:
requests generated by the UE device have a priority within a domain of the data communication system;
the notification identifies a priority level supported by the network communication component; and
transmitting the one or more held requests is performed in response to a comparison between the priority and the priority level.

5. The method of claim 4, wherein transmitting the one or more held requests is performed only if the priority level indicates that the priority is currently supported by the network communication component.

6. The method of claim 1, wherein transmitting the one or more held requests is performed in a first in, first out (FIFO) manner.

7. The method of claim 1, wherein:
transmitting the one or more held requests begins by transmitting a first held request; and
the method delays transmission of the first held request for a wait time relative to a receipt time of the notification.

8. The method of claim 1, further comprising receiving a restricted service notification from the network communication component, wherein queuing one or more requests is initialized in response to receiving the restricted service notification.

9. The method of claim 1, wherein transmitting the one or more held requests is performed in accordance with an access channel timing scheme of the data communication system.

10. The method of claim 1, wherein the notification comprises a purge queue command.

11. A user equipment (UE) device that manages requests for network resources in a data communication system having a network communication component, the UE device comprising:
a processor;
a request queue coupled to the processor, and configured to queue one or more requests for network resources as instructed by the processor, resulting in one or more held requests; and
a receiver element coupled to the processor, and configured to receive a notification from the network communication component; wherein
in response to receiving the notification, the processor prepares the one or more held requests for transmission to the network communication component beginning at a designated time that is influenced by queuing times of the one or more held requests.

12. The UE device of claim 11, wherein:
the data communication system comprises a wireless system;
the network communication component comprises a central transmit and receive station that supports a plurality of UE devices, including the UE device; and
the UE device is a wireless mobile unit.

13. The UE device of claim 12, wherein:
the wireless system comprises a cellular telecommunication system;
the central transmit and receive station comprises a base station of the cellular telecommunication system; and
each of the requests comprises a channel access request for the base station.

14. The UE device of claim 11, further comprising:
a timer arrangement coupled to the processor, the timer arrangement being configured to maintain respective timers for the one or more held requests; wherein
the timer arrangement starts a timer for a request in response to queuing of that request in the request queue; and
the timer arrangement influences a transmission order of the one or more held requests.

15. The UE device of claim 11, wherein:
the UE device has a designated priority within a domain of the data communication system, relative to other UE devices operating within the domain;
the notification identifies a priority level supported by the network communication component; and
the processor is configured to prepare the one or more held requests in response to a comparison between the designated priority and the priority level.

16. The UE device of claim 11, further comprising a transmitter element coupled to the processor, and configured to transmit the one or more held requests.

17. The UE device of claim 16, wherein the transmitter element is configured to transmit the one or more held requests in accordance with an access channel timing scheme of the data communication system.

18. A method for managing requests for resources in a wireless data communication system having a wireless network communication component that provides wireless service to wireless user equipment (UE) devices, the method comprising:
transmitting a restricted service notification from the wireless network communication component;
receiving the restricted service notification at a plurality of supported UE devices, each of the supported UE devices comprising a respective request queue;
in response to receiving the restricted service notification, each of the plurality of supported UE devices queuing any new requests for network resources in its respective request queue;
thereafter transmitting a service supported notification from the wireless network communication component;
receiving the service supported notification at one or more of the supported UE devices; and
in response to receiving the service supported notification, each of the one or more of the supported UE devices transmitting any queued requests, beginning at a calculated time that promotes a collective first in, first out behavior.

19. The method of claim 18, wherein in response to receiving the service supported notification, each of the one or more of the supported UE devices transmits its queued requests in a designated order.

20. The method of claim 18, wherein:
each of the supported UE devices has a designated priority within a domain of the wireless data communication system, relative to other devices operating within the domain;
the service supported notification identifies a priority level supported by the wireless network communication component;
each of the one or more of the supported UE devices compares its designated priority to the priority level; and
transmitting any queued requests is performed only if the priority level indicates that the designated priority is currently supported by the wireless network communication component.

21. The method of claim 18, wherein:
each of the supported UE devices has a designed priority within a domain of the wireless data communication system, relative to other devices operating within the domain;
the restricted service notification identifies a priority level restricted by the wireless network communication component;
each of the one or more of the supported UE devices compares its designated priority to the priority level; and
queuing any new requests is performed only if the priority level indicates that the designated priority is currently restricted by the wireless network communication component.

22. The method of claim 18, wherein transmitting the restricted service notification is dictated by a present operating status of the wireless network communication component.

23. The method of claim 22, wherein the present operating status comprises a wireless resource status.

24. The method of claim 18, wherein characteristics of the restricted service notification are dictated by a present operating status of the wireless network communication component.
